(19) United States
(12) Patent Application Publication
(10) Pub. No.: US 2021/0319147 A1
(43) Pub. Date: Oct. 14, 2021

(54) ULTRATHIN OMNIDIRECTIONAL VIBRATION-ISOLATION METASURFACE STRUCTURE AND DESIGN METHOD THEREOF

(71) Applicant: Northwestern Polytechnical University, Xi'an (CN)

(72) Inventors: Bing Li, Xi'an (CN); Yabin Hu, Xi'an (CN); Heyuan Huang, Xi'an (CN); Wenzhi Wang, Xi'an (CN); Chi Hou, Xi'an (CN); Meiying Zhao, Xi'an (CN); Xiaopeng Wan, Xi'an (CN); Yixin Xu, Xi'an (CN)

(21) Appl. No.: 17/350,166

(22) Filed: Jun. 17, 2021

(30) Foreign Application Priority Data
Jul. 23, 2020 (CN) 202010720385.4

(51) Int. Cl. G06F 30/10

(52) U.S. Cl. CPC G06F 30/10; G06F 2111/10

(57) ABSTRACT

The present invention relates to an ultrathin omnidirectional vibration-isolation metasurface structure and a design method thereof. The omnidirectional vibration-isolation metasurface structure includes a flat plate and a vibration isolation metasurface structure arranged on the flat plate. The vibration isolation metasurface structure is designed in any closed shape according to the shape and position of a vibration source. The vibration isolation metasurface structure is composed of periodically arranged supercells. Each supercell includes j unit cells with a gradient index. The unit cell is in a zigzag shape. The total reflection of elastic waves at any incident angle is realized by designing an elastic wave metasurface with a sub-wavelength thickness in the present invention, so that a vibration isolation purpose is achieved. The metasurface has the characteristics of light and thin structure, small volume, wide work frequency range and capability of achieving 360-degree omnidirectional vibration isolation.

### CROSS-REFERENCE TO RELATED APPLICATIONS

This application claims the benefit of priority from Chinese Patent Application No. 202010720385.4, filed on Jul. 23, 2020. The content of the aforementioned application, including any intervening amendments thereto, is incorporated herein by reference.

### TECHNICAL FIELD

The present invention relates to the technical field of vibration isolation of an engineering structure, and in particular relates to an ultrathin omnidirectional vibration-isolation metasurface structure and a design method thereof.

### BACKGROUND OF THE PRESENT INVENTION

Vibration and noise problems generally exist in engineering structures, and are extremely common particularly in aerospace, ships, vehicles, civil construction and other fields closely related to the structural dynamics. Violent vibration may make drivers and passengers feel fatigued and reduce the riding conformity on one hand; and on the other hand, the dynamical mechanical properties of the structure may be affected seriously, the sensitivity of electronic elements and devices may be interfered, and the instability of the structure can be increased. Moreover, the fatigue damage may be caused, resulting in failure of overall performance of the structure. Therefore, how to effectively implement the vibration isolation is always one of key problems in the vibration and noise control field. The existing vibration isolation structure design methods may be classified into three categories: passive control, active control, and semi-active control. The passive control mainly depends on that an additional damping vibration isolator absorbs the vibration energy inside a basal body, so that the vibration reduction/isolation purpose can be achieved without external energy. However, the passive vibration isolation depends on traditional damping vibration isolators which are generally large in mass. How to achieve the lightweight and efficient vibration isolation is still a difficult problem to be solved urgently in a case where the mass is limited. The active vibration isolation technology mainly depends on the input of the external energy, and realizes a purpose of structural vibration control by applying an additional acting force to the structure. The active control strategy has the advantages of controllable bandwidth, adjustability with environment and the like. However, the external energy input device required for the active control is generally large in volume, complicated in design and low in system reliability, which seriously restricts the wider application. Although the semi-active vibration isolation method combines the advantages of the active control and the passive control, it still depends on the precise circuit system design, and still needs to further enhance and improve the energy conversion efficiency, the mass and the volume.

### SUMMARY OF THE PRESENT INVENTION

In order to solve the above problems, the present invention provides an ultrathin omnidirectional vibration-isolation metasurface structure and a design method thereof. The proposed metasurface structure can effectively realize omnidirectional isolation for elastic waves caused by the vibration, and can isolate one or more wave sources, thereby fundamentally solving the vibration propagation problem; and the purpose can be realized only by two types of unit cells. The structure can be designed in any shape according to the actual condition, so that the structure is light and thin, capable of satisfying the use requirements in different environments and more practical. At the same time, the structure is wide in effective work frequency band, wide in effective isolation angle range, low in material requirement, low in price, and convenient in production and processing.

In order to realize the above purpose, the present invention adopts a technical solution as follows:

An ultrathin omnidirectional vibration-isolation metasurface structure includes a flat plate and a vibration isolation metasurface structure arranged on the flat plate. The metasurface structure is designed in any closed shape according to the shape and position of a vibration source. The metasurface structure is composed of periodically arranged supercells. Each supercell includes j unit cells with a gradient index. The unit cell is in a zigzag shape.

Further, the j unit cells with the gradient index can make the phase change cover the range of 2π. Each unit cell has a width of H; the zigzag width is d; each supercell has a width of j·H; and the phase gradient of the metasurface is

$$\frac{d ϕ}{d y} = \frac{2 π}{j \cdot H} ,$$

wherein ϕ indicates phase change; j represents the number of the unit cells; and H represents the width of the unit cell. When −1<sin θₜ<1 is satisfied, elastic waves can be transmitted after passing through the metasurface. θₜ indicates an angle between the transmitted waves and a normal of the metasurface, i.e. a transmission angle. Therefore, in order to avoid the transmission of elastic waves at any incident angle, the phase gradient of the metasurface structure needs to satisfy

$$\frac{d ϕ}{d y} \geq \frac{4 π}{λ} .$$

Further, a thickness t of the unit cell is 1.5 mm; the zigzag width d is 1.5 mm; h is a zigzag height; the width H of the unit cell is less than 7.5 mm; and a total length l of the unit cell is 20.5 mm.

The present invention further provides a design method of the ultrathin omnidirectional-vibration isolation metasurface structure, which includes the following steps:

S1, writing a material density, Young modulus and poisson ratio of a vibration isolation metasurface structure and a flat plate respectively as ρ, E and v; building a finite element model of a unit cell, including a basal body medium and a metasurface unit cell structure, wherein an upper border and a lower border of the model are provided with a perfect matching layer; and applying a simple harmonic force load to one side of the metasurface unit cell structure, sweeping the zigzag height h in a frequency domain, and calculating phase change Δϕ and transmissivity |t| corresponding to different h;

S2, selecting the unit cells with different heights for designing a supercell, so that a phase gradient meets a total reflection requirement, and using the supercell as a basic unit of the metasurface;

S3, designing different arrangement ways of the supercells according to the position and shape of a vibration source, and building the metasurface structure to realize the omnidirectional reflection, thereby meeting requirements of vibration isolation.

The present invention has the following beneficial effects:

The total reflection of the elastic waves at any incident angle is realized by designing an elastic wave metasurface with a sub-wavelength thickness, so that a vibration isolation purpose is achieved. The metasurface has the characteristics of light and thin structure, small volume, wide work frequency range and capability of achieving 360-degree omnidirectional vibration isolation.

The metasurface of the present invention is formed by arranging the same supercells, and different shapes can be designed according to the application requirements in different environments, so that the wave source in any position can be effectively isolated in a wide frequency range.

The metasurface of the present invention is integrated with the peripheral flat plate and made of the same material. A thin plate with the metasurface is fabricated by wire electrical-discharge machining so that the processing precision is high, and the production is convenient.

### BRIEF DESCRIPTION OF THE DRAWINGS

FIG. 1 is a schematic diagram of metasurface controlling waves;

FIG. 2 is an enlarged view of a unit cell structure;

FIG. 3 shows the change trend of a transmissivity amplitude and phase of a unit cell with a zigzag height h;

FIG. 4 shows a change trend of the transmissivity amplitude of a linear metasurface with an incident angle θₜ and a frequency f,

FIG. 5 is a structural schematic diagram of a metasurface structure with linearly arranged supercells;

FIG. 6 is a structural schematic diagram of a circular omnidirectionally reflected metasurface;

FIG. 7 is a structural schematic diagram of a square omnidirectionally reflected metasurface;

FIG. 8 is a displacement field distribution diagram of a circular omnidirectionally reflected metasurface structure under the excitation of internal and external point sources at 15 kHz;

FIG. 9 is a displacement field distribution diagram of a square omnidirectionally reflected metasurface structure under the excitation of internal and external point sources at 15 kHz.

Reference numerals: 1—flat plate; 2—metasurface; 3—internal wave source; 4—external wave source.

### DETAILED DESCRIPTION OF THE PRESENT INVENTION

The present invention is described in detail below in combination with specific embodiments. The following embodiments may help those skilled in the art to further understand the present invention, but do not limit the present invention in any form. It should be pointed out that various modifications and improvements may be made by those ordinary skilled in the art without departing from the concept of the present invention. These modifications and improvements belong to the protection scope of the present invention.

An ultrathin omnidirectional vibration isolation metasurface structure provided by an embodiment of the present invention utilizes metasurfaces to realize the omnidirectional vibration isolation. The basic principle is: by designing the metasurface, incident elastic waves from any direction may be diffracted in high order, and the high-order waves will propagate in a total-reflection form, thereby realizing the omnidirectional vibration isolation. The metasurface controls the elastic waves caused by the vibration based on generalized Snell law, that is,

$$sin {θ}_{t} = sin {θ}_{i} + \frac{λ}{2 π} \frac{d ϕ}{dy} \qquad ( 1 )$$

wherein θᵢ is an incident angle; θₜ is a transmission angle; λ is a wavelength; and

$$\frac{d ϕ}{d y}$$

is a phase gradient of the metasurface.

The omnidirectional reflected metasurface structure includes a flat plate and a metasurface arranged on the flat plate. As shown in FIG. 1, the metasurface is composed of periodically arranged supercells. Each supercell includes j unit cells with a gradient index. By changing the gradient index parameter of the unit cells, the elastic waves may have different phase delay when passing through the metasurface unit cells. Each supercell contains j unit cells, so that the phase change may cover a range of 2π. Each unit cell has a width of H. The supercell has a width of j·H. The phase gradient of the metasurface is

$$\frac{d ϕ}{d y} = \frac{2 π}{j \cdot H} .$$

The phase gradient is changed not to satisfy the condition, so that the elastic waves may have total reflection. When −1<sin θₜ<1 is satisfied, the elastic waves can be transmitted after passing through the metasurface. Therefore, when the phase gradient of the metasurface satisfies

$$\frac{d ϕ}{d y} \geq \frac{4 π}{λ} ,$$

the total reflection may be realized at any incident angle. The metasurface structure can be designed in any closed shape according to the shape and position of a vibration source, so that the elastic waves generated by the vibration can be completely reflected at 360°. The metasurface structure firmly traps the vibration source like a “cage” and cuts the propagation, thereby realizing the vibration isolation purpose.

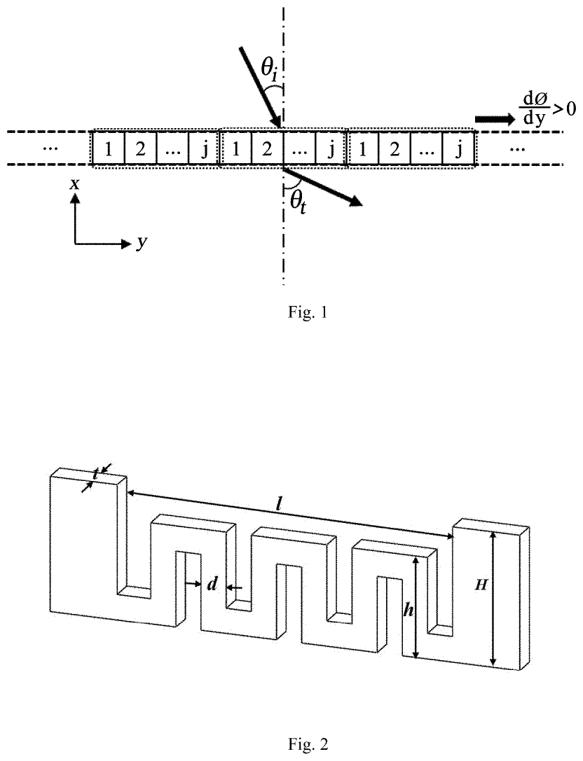

The unit cell is designed in a zigzag shape. As shown in FIG. 2, t is a thickness of the flat plate; d is a zigzag width; h is a zigzag height; H is a width of the unit cell; and l is a total length of the unit cell. The smaller the thickness t of the flat plate is, the easier the wave A0 is excited. The larger the zigzag width is, the greater the transitivity of the unit cell is, but l is required to satisfy the scale of the sub-wavelength, which is set as t=1.5 mm, d=1.5 mm and l=20.5 mm.

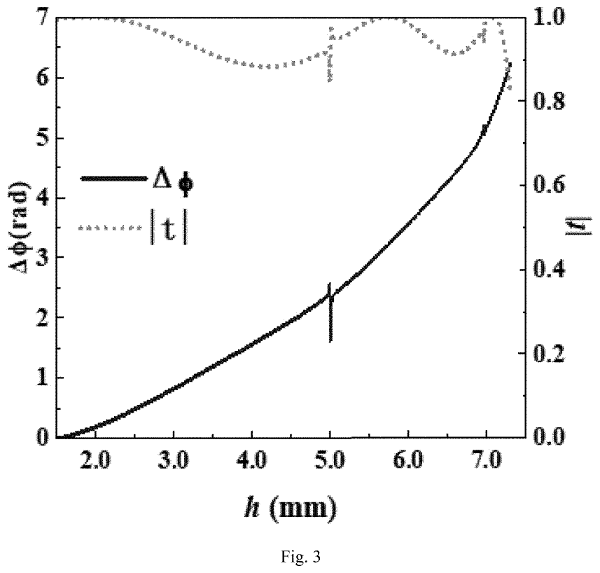

A purpose of covering 2π by phase change of elastic waves after passing through the unit cells may be realized by changing h of the metasurface unit cell. The change curve of the transmittivity |t| and the phase change Δϕ with h is as shown in FIG. 3. Each supercell of the metasurface includes 2 unit cells which are written as cell-1 and cell-2. Based on the change trend of the phase gradient and h, the zigzag heights of the cell-1 and cell-2 are respectively 2.8 mm and 6.2 mm. The width H of the unit cell is only required to be less than 7.5 mm.

An embodiment of the present invention provides a design method of the ultrathin metasurface structure for omnidirectional vibration isolation, which includes the following steps:

S1, a material density, Young modulus and poisson ratio of metasurface structure and a flat plate are written respectively as ρ, E and v; a finite element model of a unit cell is built, which includes a basal body medium and a metasurface unit cell structure, wherein an upper border and a lower border of the model are provided with a perfect matching layer; and a simple harmonic force load is applied to one side of the metasurface unit cell structure, a zigzag height h is swept in a frequency domain, and phase change Δϕ and transmissivity t corresponding to different zigzag heights h are calculated;

S2, the unit cells with different heights are selected for designing a supercell, so that a phase gradient meets a total reflection requirement, and the supercell is used as a basic unit of the metasurface structure;

S3, different arrangement ways of the supercells are designed according to the position and shape of a vibration source, and the metasurface structure is built to realize the omnidirectional reflection, thereby meeting vibration isolation requirements.

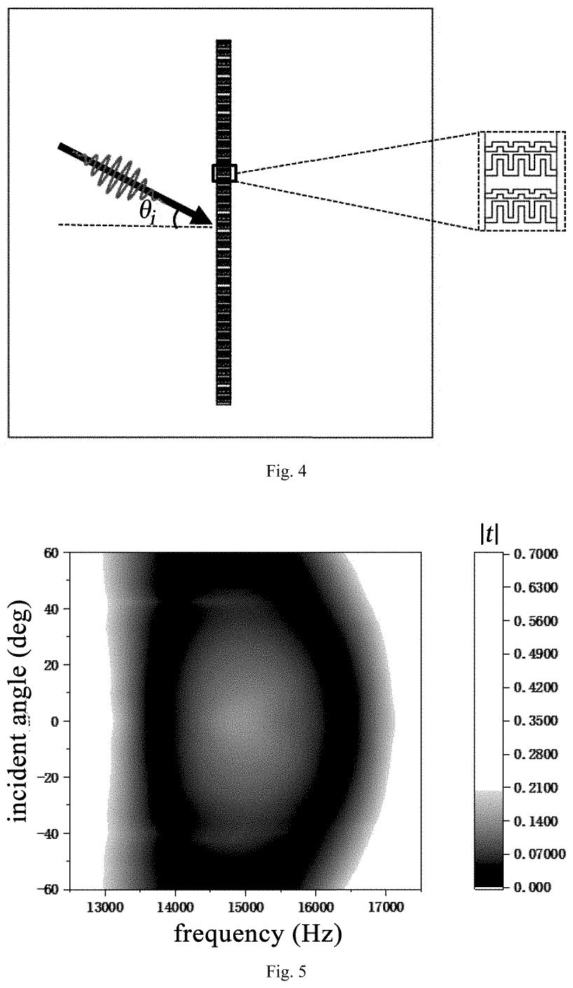

The metasurface structure for vibration isolation of the present embodiment is composed of three portions, including a flat plate, metasurfaces composed of periodically arranged units, and a wave source. The structure is made of stainless steel 304. The density, Young modulus and poisson ratio are respectively 7930 kg/m³, 200 Gpa and 0.3. To verify the effects of different incident angles and frequencies on the vibration isolation character, the metasurface with linearly-arranged supercells is designed, as shown in FIG. 4.

COMSOL Multiphysics finite element analysis software is used to build a whole finite element model. The finite element model includes a flat plate, a metasurface, a wave source and a perfect matching layer. The flat plate and the metasurface are divided by a combination of a free triangular mesh and a sweeping mesh. The perfect matching layer is meshed by a combination of a mapping mesh and a sweeping mesh. A solid mechanical module is used for research in a frequency domain and endows the whole model with material properties. Parameters of the perfect matching layer are set. Gaussian beams with a frequency of 15 kHz and amplitude of 1 e-7 N/m² are generated in an interface of an incident area and the perfect matching layer. Parameter scanning is performed on the incident angle and the frequency to obtain a change curve of the transmissivity with the incident angle and frequency, as shown in FIG. 5.

According to calculation results, the metasurface has good isolation effect on incident waves at any incident angle within a range of 13 kHz-16.5 kHz. The transmissivity is generally less than 0.2.

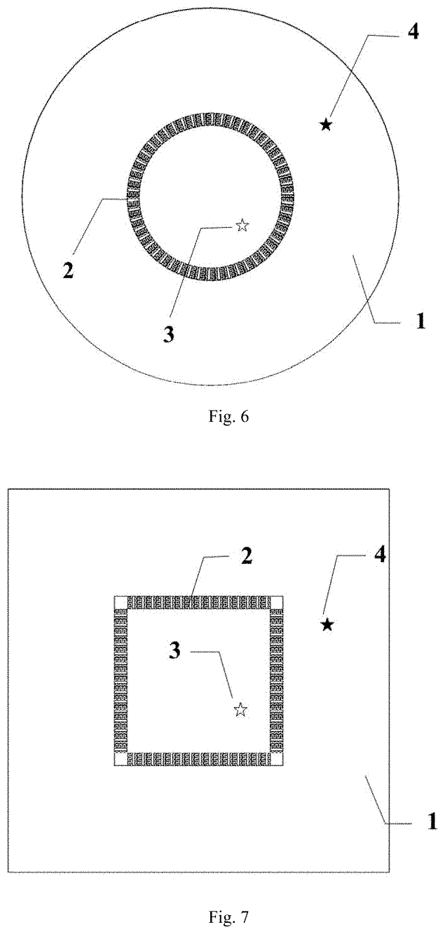

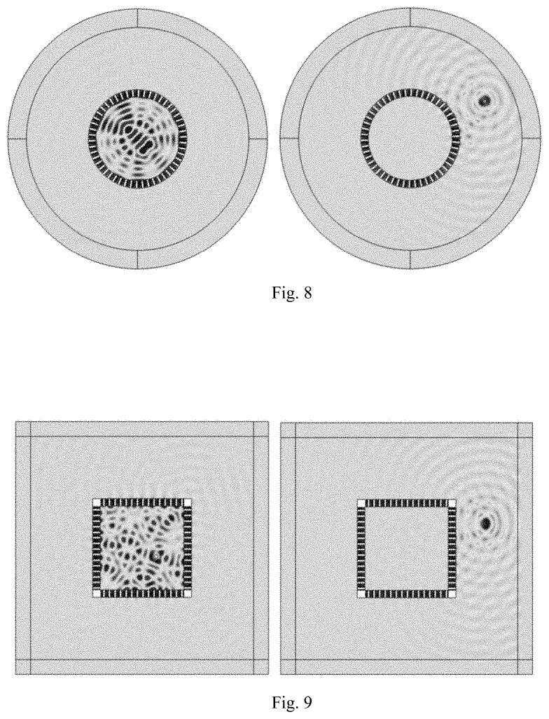

The present invention verifies the vibration isolation effect through a circular (FIG. 6) case and a square (FIG. 7) cage. The wave source is located in any position in the cage. The displacement field distribution diagram of the circular metasurface structure under the excitation of internal and external point sources at 15 kHz is as shown in FIG. 8. The displacement field distribution diagram of the square metasurface structure under the excitation of the internal and external point sources at 15 kHz is as shown in FIG. 9. When the wave source is inside the cage, the structures of two shapes trap almost all the elastic waves inside the structure, so that the exterior of the structure is not affected by the wave source. When the wave source is outside the cage, the structures of the two shapes well prevent the elastic waves from radiating into the structure, and the interior of the structure is hardly affected by the wave source.

The present invention is light and thin in volume, good in vibration isolation effect, simple in structure, and convenient in processing. No damping characteristic is considered in the design, so that the shortcomings of damping materials can be avoided. The unit size is small, and no external energy supply is needed. The protection scope can be adjusted according to the actual condition, thereby having high economic performance and environmental adaptability.

The specific embodiments of the present invention are described above. It shall be understood that the present invention is not limited to the above specific embodiments. Those skilled in the art can make various modifications or changes within the scope of the claims without influencing the substantive content of the present invention. In the case of no conflict, the embodiments of the present application and the features in the embodiments can be combined randomly.

1. An ultrathin omnidirectional vibration-isolation metasurface structure, comprising a flat plate and a vibration isolation metasurface structure arranged on the flat plate, wherein the vibration isolation metasurface structure is designed in any closed shape according to the shape and position of a vibration source; the vibration isolation metasurface structure is composed of periodically arranged supercells; each supercell comprises j unit cells with a gradient index; and the unit cell is in a zigzag shape.

2. The ultrathin omnidirectional vibration-isolation metasurface structure according to claim 1, wherein the j unit cells with the gradient index can make the phase change cover the range of 2π; each unit cell has a width of H; the zigzag width is d; each supercell has a width of j·H; and the phase gradient of the metasurface is
$$\frac{d ϕ}{d y} = \frac{2 π}{j \cdot H} ,$$
wherein ϕ indicates phase change; j represents the number of the unit cells; H represents the width of the unit cell; and the phase gradient of the omnidirectionally reflected metasurface structure satisfies
$$\frac{d ϕ}{d y} \geq \frac{4 π}{λ} .$$

3. The ultrathin omnidirectional vibration isolation metasurface structure according to claim 1, wherein a thickness t of the unit cell is 1.5 mm; the zigzag width d is 1.5 mm; h is a zigzag height; the width H of the unit cell is less than 7.5 mm; and a total length l of the unit cell is 20.5 mm.

4. A design method of the ultrathin omnidirectional vibration-isolation metasurface structure of claim 1, comprising the following steps:
S1, writing a material density, Young modulus and poisson ratio of a vibration isolation metasurface structure and a flat plate respectively as ρ, E and v; building a finite element model of a unit cell, comprising a basal body medium and a metasurface unit cell structure, wherein an upper border and a lower border of the model are provided with a perfect matching layer; and applying a simple harmonic force load to one side of the metasurface unit cell structure, sweeping the zigzag height h in a frequency domain, and calculating phase change Δϕ and transmissivity |t| corresponding to different zigzag heights h;
S2, selecting the unit cells with different heights for designing a supercell, so that a phase gradient meets a total reflection requirement, i.e.
$$\frac{d ϕ}{d y} \geq \frac{4 π}{λ} ,$$
and using the supercell as a basic unit of the vibration isolation metasurface structure;
S3, designing different arrangement ways of the supercells according to the position and shape of a vibration source, and building the vibration isolation metasurface structure to realize the omnidirectional reflection, thereby meeting vibration isolation requirements.

5. A design method of the ultrathin omnidirectional vibration-isolation metasurface structure of claim 2, comprising the following steps:
S1, writing a material density, Young modulus and poisson ratio of a vibration isolation metasurface structure and a flat plate respectively as ρ, E and v; building a finite element model of a unit cell, comprising a basal body medium and a metasurface unit cell structure, wherein an upper border and a lower border of the model are provided with a perfect matching layer; and applying a simple harmonic force load to one side of the metasurface unit cell structure, sweeping the zigzag height h in a frequency domain, and calculating phase change Δϕ and transmissivity |t| corresponding to different zigzag heights h;
S2, selecting the unit cells with different heights for designing a supercell, so that a phase gradient meets a total reflection requirement, i.e.
$$\frac{d ϕ}{d y} \geq \frac{4 π}{λ} ,$$
and using the supercell as a basic unit of the vibration isolation metasurface structure;
S3, designing different arrangement ways of the supercells according to the position and shape of a vibration source, and building the vibration isolation metasurface structure to realize the omnidirectional reflection, thereby meeting vibration isolation requirements.

6. A design method of the ultrathin omnidirectional vibration-isolation metasurface structure of claim 3, comprising the following steps:
S1, writing a material density, Young modulus and poisson ratio of a vibration isolation metasurface structure and a flat plate respectively as ρ, E and v; building a finite element model of a unit cell, comprising a basal body medium and a metasurface unit cell structure, wherein an upper border and a lower border of the model are provided with a perfect matching layer; and applying a simple harmonic force load to one side of the metasurface unit cell structure, sweeping the zigzag height h in a frequency domain, and calculating phase change Δϕ and transmissivity |t| corresponding to different zigzag heights h;
S2, selecting the unit cells with different heights for designing a supercell, so that a phase gradient meets a total reflection requirement, i.e.
$$\frac{d ϕ}{d y} \geq \frac{4 π}{λ} ,$$
and using the supercell as a basic unit of the vibration isolation metasurface structure;
S3, designing different arrangement ways of the supercells according to the position and shape of a vibration source, and building the vibration isolation metasurface structure to realize the omnidirectional reflection, thereby meeting vibration isolation requirements.
